(19) United States
(12) Patent Application Publication
(10) Pub. No.: US 2021/0125426 A1
(43) Pub. Date: Apr. 29, 2021

(54) VEHICLE ELECTRONIC LOGGING SYSTEM

(71) Applicant: Stoneridge, Inc., Novi, MI (US)

(72) Inventors: Fabio Bibiano Nista, Campinas (BR); Thiago Crivelaro do Nascimento, Paulínia (BR); Anderson Fernandes, Paulínia (BR); Carlos Machado de Oliveira, Campinas (BR)

(21) Appl. No.: 17/082,744

(22) Filed: Oct. 28, 2020

Related U.S. Application Data
(60) Provisional application No. 62/926,793, filed on Oct. 28, 2019.

(51) Int. Cl. G07C 5/00; G07C 5/08; B60S 1/08; B60R 25/33; G07C 9/00

(52) U.S. Cl. CPC G07C 5/008; G07C 5/0841; G08G 1/20; B60R 25/33; G07C 9/00571; B60S 1/0896

(57) ABSTRACT

An example method includes utilizing a global navigation satellite system (GNSS) receiver to determine a location of a vehicle, and determining, based on the location of the vehicle, whether the vehicle has crossed a territorial boundary associated with a location for loading or unloading cargo from a trailer of the vehicle. Based on the vehicle having crossed the territorial boundary, a state of a lock of the trailer is changed from a first state to a second state. Another example method includes comparing a speed of a vehicle to a predefined speed threshold, providing a notification based on the speed of the vehicle exceeding the predefined speed threshold, detecting that a windshield wiper of the vehicle is activated for more than a predefined duration of time, and based on the detecting, reducing the predefined speed threshold. Apparatus configured to perform the methods are also disclosed.

### CROSS-REFERENCE TO RELATED APPLICATIONS

This application claims priority to U.S. Provisional Application No. 62/926,793 which was filed on Oct. 28, 2019, and is incorporated herein by reference in its entirety.

### BACKGROUND

This application relates to electronic logging, and more particularly to an electronic logging system for vehicles.

Government regulations require drivers of commercial vehicles to record the number of hours driven in given time period as part of maintaining an hours-of-service (HOS) log. Such logs are meant to ensure that drivers do not exceed a maximum number of permitted driving hours in the given time period. Historically, this has involved drivers maintaining cumbersome paper-based non-electronic logs.

### SUMMARY

A method according to an example of the present disclosure includes utilizing a global navigation satellite system (GNSS) receiver to determine a location of a vehicle, and determining, based on the location of the vehicle, whether the vehicle has crossed a territorial boundary associated with a location for loading or unloading cargo from a trailer of the vehicle. The method includes, based on the vehicle having crossed the territorial boundary, changing a state of a lock of the trailer from a first state to a second state.

In a further embodiment of any of the foregoing embodiments, the determining includes determining that the vehicle is approaching the location and is within a predefined distance of the location, and the changing a state of the lock includes, based on the determination that the vehicle is approaching the location and is within a predefined distance of the location, changing the lock from the first state, which is a locked state, to the second state, which is an unlocked state.

In a further embodiment of any of the foregoing embodiments, the location is a loading bay, and the method includes transmitting a notification to the loading bay or an individual associated with the loading bay based on the determining that the vehicle is approaching the location and is within a predefined distance of the location.

In a further embodiment of any of the foregoing embodiments, the determining includes determining that the vehicle is increasing its distance from the location and is more than a predefined distance away from the location, and the changing a state of the lock includes, based on the determination that the vehicle is increasing its distance from the location and is more than a predefined distance away from the location, changing the lock from the first state, which is an unlocked state, to the second state, which is an locked state.

A device for a vehicle, according to an example of the present disclosure includes a GNSS receiver, and a processor. The processor is configured to utilize the GNSS receiver to determine a location of the vehicle, and determine, based on the location of the vehicle, whether the vehicle has crossed a territorial boundary associated with a location for loading or unloading cargo from a trailer of the vehicle. The processor is configured to, based on the vehicle having crossed the boundary, change a state of a lock of the trailer from a first state to a second state.

In a further embodiment of any of the foregoing embodiments, the processor is configured to change the state of the lock from the first state, which is a locked state, to the second state, which is an unlocked state, based on the determination that the vehicle has crossed the territorial boundary and further based on a determination that the vehicle is approaching the location and is within a predefined distance of the location.

In a further embodiment of any of the foregoing embodiments, the location is a loading bay, and the processor is configured to transmit a notification to the loading bay or an individual associated with the loading bay based on the determinations that the vehicle has crossed the territorial boundary, is approaching the location, and is within a predefined distance of the location.

In a further embodiment of any of the foregoing embodiments, the processor is configured to change the state of the lock from the first state, which is an unlocked state, to the second state, which is an locked state, based on the determination that the vehicle has crossed the territorial boundary and further based on a determination that the vehicle is increasing its distance from the location and is more than a predefined distance away from the location.

A method according to an example of the present disclosure includes comparing a speed of a vehicle to a predefined speed threshold, providing a notification based on the speed of the vehicle exceeding the predefined speed threshold, detecting that a windshield wiper of the vehicle is activated for more than a predefined duration of time, and based on the detecting, reducing the predefined speed threshold.

In a further embodiment of any of the foregoing embodiments, the predefined duration of time corresponds to a time period during which the windshield wiper is automatically activated based on windshield washer fluid being dispensed by the vehicle.

In a further embodiment of any of the foregoing embodiments, providing a notification includes, providing a visual notification, an audible notification, or both, to a driver of the vehicle.

In a further embodiment of any of the foregoing embodiments, providing a notification includes transmitting a notification to a fleet manager of the vehicle.

In a further embodiment of any of the foregoing embodiments, the method is performed by an electronic logging device of the vehicle, the electronic logging device connected to an information bus of the vehicle. The electronic logging device performs the detection based on information received over the information bus, and the method includes recording, by the electronic logging device, data describing operation of the vehicle.

In a further embodiment of any of the foregoing embodiments, the method includes determining the speed of the vehicle based on at least one of data from a GNSS receiver and data received over the information bus.

A device according to an example of the present disclosure includes memory, and a processor operatively connected to the memory and configured to compare a speed of a vehicle to a predefined speed threshold. The processor provides a notification based on the speed of the vehicle exceeding the predefined speed threshold, detects that a windshield wiper of the vehicle is activated for more than a predefined duration of time, and based on the detection, reduces the predefined speed threshold.

In a further embodiment of any of the foregoing embodiments, the predefined duration of time corresponds to a time period during which the windshield wiper is automatically activated based on windshield washer fluid being dispensed by the vehicle.

In a further embodiment of any of the foregoing embodiments, to provide the notification, the processor is configured to provide a visual notification, an audible notification, or both, to a driver of the vehicle.

In a further embodiment of any of the foregoing embodiments, to provide the notification, the processor is configured to transmit a notification to a fleet manager of the vehicle.

In a further embodiment of any of the foregoing embodiments, the device is an electronic logging device of the vehicle. The electronic logging device connects to an information bus of the vehicle, is configured to perform the detection based on information received over the information bus, and is configured to record data describing operation of the vehicle.

In a further embodiment of any of the foregoing embodiments, the processor is configured to determine the speed of the vehicle based on at least one of data from a GNSS receiver and data received over the information bus.

### BRIEF DESCRIPTION OF THE DRAWINGS

FIG. 1 is a schematic view of an electronic logging system.

FIG. 2 is a schematic view of an electronic logging device in a vehicle.

FIG. 3 schematically illustrates an example electronic logging device.

FIG. 4 schematically illustrates an example territorial boundary.

FIG. 5 is a flowchart that illustrates an example method for a vehicle.

FIG. 6 is a flowchart that illustrates another example method for a vehicle.

FIG. 7 schematically illustrates a multi-level permission hierarchy for providing fleet managers with hierarchical access to vehicle operation data.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

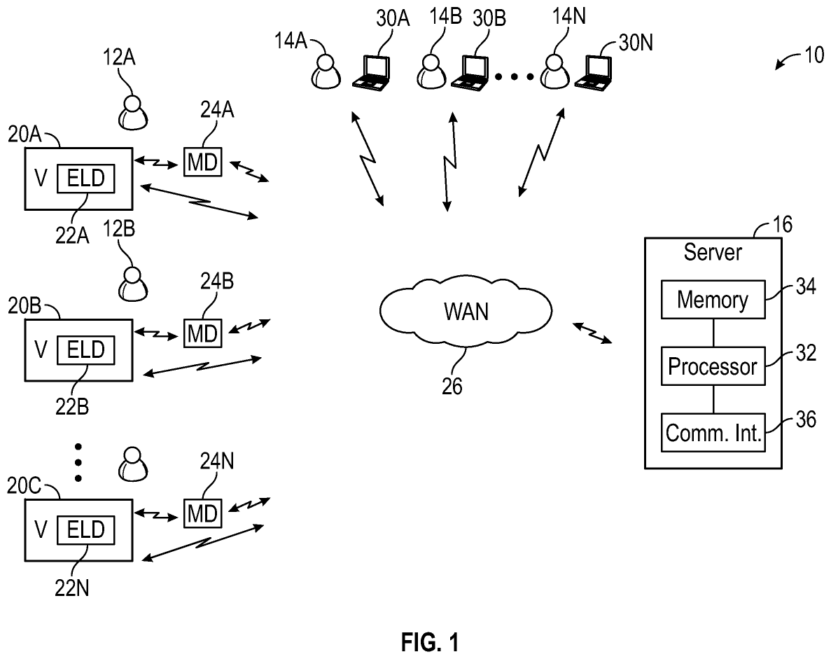

FIG. 1 schematically illustrates an example electronic logging system 10 that includes a plurality of drivers 12A-N and a plurality of fleet managers 14A-N. Each driver 12 is associated with a corresponding vehicle 20. At least one server 16 is provided for storing vehicle operation data for the drivers 12 and vehicles 20. The server 16 can be accessed by the drivers 12 and fleet managers 14 for accessing vehicle operation information.

Each vehicle 20 includes an associated electronic logging device (“ELD”) 22 that can communicate with the server 16 over a wide area network (“WAN”) 26, such as the internet. Each driver 12 has an associated mobile device 24 (e.g., a smartphone or tablet) that can locally communicate with the ELD 22 and can also communicate with the server 16 over the WAN 26.

Each fleet manager 14 has an associated computing device 30 that they can use to obtain vehicle operation data from the server 16. Although the computing devices 30 are depicted as laptops, it is understood that other computing devices could be used (e.g., desktop computers, tablets, etc.). Also, although “N” (e.g., 24N, 30N, etc.) is used to show an upper bound of a range of items, it is understood that different values of “N” could be used (e.g., so that the quantity of vehicles 20 can differ from the quantity of fleet managers 14), and that N could represent any quantity.

The server 16 includes a processor 32 that is operatively connected to memory 34 and a communication interface 36. The processor 32 includes processing circuitry, which may include one or more microprocessors, microcontrollers, application specific integrated circuits (ASICs), or the like, for example. The memory 34 stores a repository of vehicle operation data, and can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 304 may incorporate electronic, magnetic, optical, and/or other types of storage media. The memory 304 can also have a distributed architecture, where various components are situated remotely from one another, but can be accessed by the processor 32.

The communication interface 36 is configured to facilitate communication with the ELDs 22, mobile devices 24, and/or computing devices 30. The communication interface may include an Ethernet card or a wireless transceiver, for example.

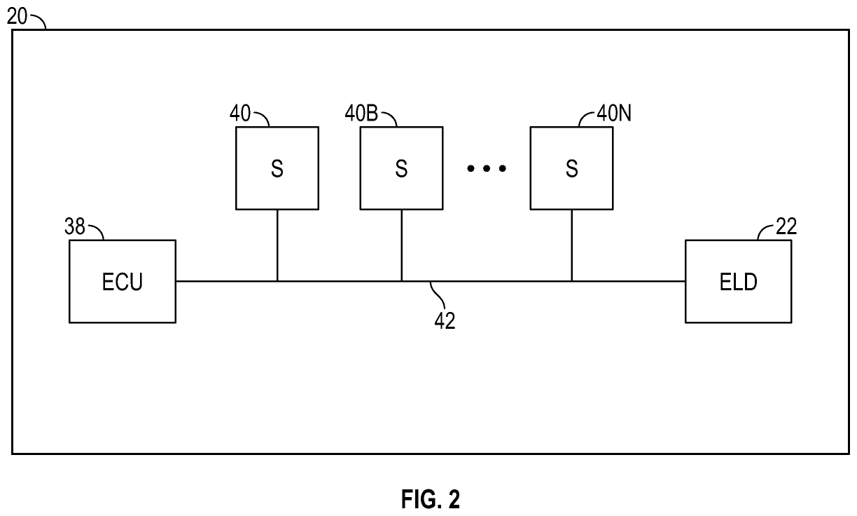

FIG. 2 is a schematic view of an ELD 22 in a vehicle 20. As shown in FIG. 2, the vehicle 20 also includes an electronic control unit 38 and a plurality of sensors 40A-N. The ELD 22, ECU 38, and sensors 40 communicate over an information bus 42, which is a controller area network (“CAN”) bus in one example. The sensors 40 and/or ECU 38 are configured to provide data describing a variety of vehicle operation information, which may include any of the following: vehicle ignition status (e.g., ON/OFF), vehicle power system status (e.g., ON/OFF), vehicle speed, vehicle temperature, vehicle windshield wiper status, engine RPMs, etc.

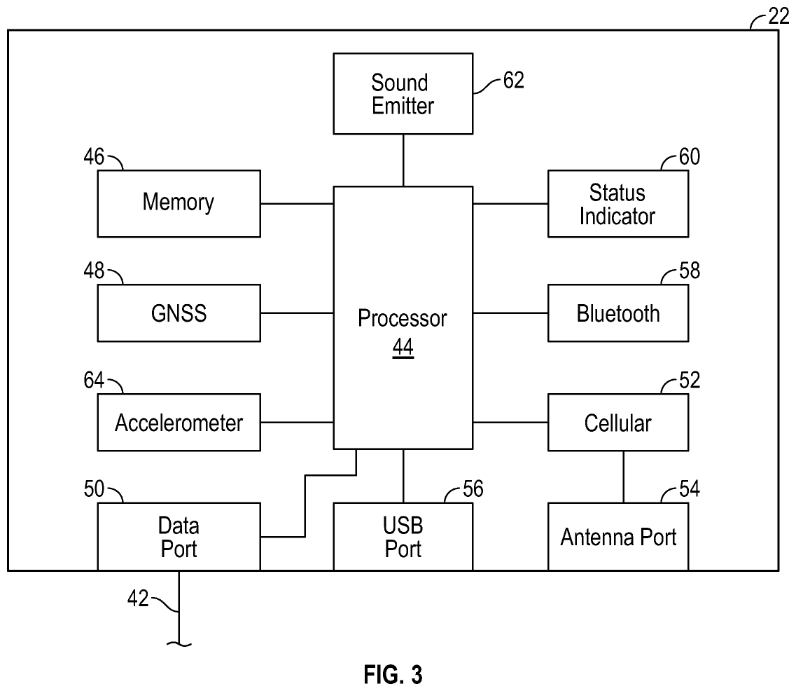

FIG. 3 illustrates an example implementation of the ELD 22 of FIG. 1.

The ELD 22 includes a processor 44 operatively connected to memory 46. The processor 44 and memory 46 may include any of the hardware features discussed above in connection with the processor 32 and memory 34, respectively.

A global navigation satellite system (GNSS) receiver 48 (e.g., a GPS receiver) is configured to determine a location of the ELD 22, which is indicative of a location of the vehicle 20 associated with the ELD 22. In one example, the processor 44 is configured to use GNSS data from the GNSS receiver 48 to determine a speed of the vehicle 20 and/or to provide a virtual odometer for the vehicle 20.

One or more data ports 50 are provided for connection to the information bus 42 for communicating with the ECU 38 and/or sensors 40 and/or for communicating with actuators for other vehicle systems (e.g., for issuing a command to lock or unlock a trailer of the vehicle 20). In one example, the data port 50 connects the ELD 22 to a CAN bus of the vehicle 20. In one example, the data port 50 is an on-board diagnostics (ODB) or RP1226 telematics port.

A cellular transceiver 52 is configured to transmit vehicle operation data to the server 16. Optionally, an antenna port 54 may provide for connection to an external antenna (not shown) to improve signal quality. The cellular transceiver 52 is configured to communicate using a cellular communication standard, such as one or more 3GPP standards (e.g., GSM, W-CDMA, LTE, LTE-M, etc.) and/or one or more IEEE standards (e.g., WiMAX). By including the cellular transceiver 52, the ELD 22 does not need to rely on the driver's mobile device 24 for communicating with the server 16, and thus can avoid being subjected to data plan and/or data transmission limitations of the mobile device 24. In one example, the cellular transceiver 52 is used for downloading over-the-air firmware updates for the ELD 22.

A USB port 56 is provided for wired communication with mobile device 24, and a Bluetooth transceiver 58 is provided for wireless communication with the mobile device 24. Local communications through the USB port 56 and/or Bluetooth transceiver 58 could be used to authenticate drivers 12. Such authentication could include the driver 12 entering a password, providing biometric information (e.g., a thumbprint), and/or transmitting some other token or credential from their mobile device 24 to the ELD 22.

A status indicator 60 (e.g., a light-emitting diode or “LED”) is provided for indicating a status of the ELD 22. In one example, the status indicator 60 indicates whether the ELD 22 is operational and/or connected to a cellular network.

A sound-emitting device 62 (e.g., a speaker or buzzer) is configured to provide audio alerts, such as, e.g., an alarm to indicate that a speed of the vehicle 20 exceeds a maximum permitted speed threshold and/or to indicate the driver 12 has exceeded a maximum permitted driving time during a particular time period.

An accelerometer 64, which may be a three-dimensional accelerometer, is configured to determine acceleration information of the vehicle 20. Such information could be used by the ELD 22 or server 16 to determine if a driver 12 is driving erratically (e.g., rapid acceleration/deceleration and/or swerving).

The ELD 22 can be used by drivers 12 and/or fleet managers 14 to maintain hours-of-service (HOS) logs (e.g., those required by regulations of the Federal Motor Carrier Safety Administration (“FMCSA”), which is the government entity that regulates the trucking industry in the United States). Such logs could include vehicle operation data received from the data port 50 or independently determined by the ELD 22, along with a time stamp, vehicle identifier (e.g., VIN as determined from the information bus 42), and driver identifier, as multiple drivers 12 may drive a vehicle at different times. In one example, it is the server 16 that maintains long term logs, with the ELD 22 maintaining a shorter term log as a buffer (e.g., in case cellular reception is lost and the ELD 22 temporarily cannot transmit data to the server 16).

In one example, the ELD 22 polls and/or logs different types of vehicle data at different intervals. For example, vehicle speed could be determined and recorded at a first interval (e.g., every minute), vehicle temperature could be measured and recorded at a second interval (e.g., every 10 minutes), and vehicle RPMs or vehicle windshield wiper operation information could be measured and recorded at a third interval (e.g., every 30 minutes). Of course, other measurements and intervals could be used. The vehicle operation data that is recorded may depend on the particular vehicle 20 being monitored, as some vehicles may offer greater amounts of vehicle operation information on their information bus 42 than other vehicles.

Certain vehicle operation events may be of particular interest to a fleet manager 14, such as speed alerts, ignition ON/OFF, main power supply connected/disconnected, and vehicle operation information corresponding to those events may be polled and/or logged at a shorter interval than information indicative of other events.

In addition to creating logs of vehicle operation data, the ELD 22 may also be used to provide additional features, which may be useful for fleet managers 14 and/or third parties, such as vehicle rental companies.

In one example, fleet managers 14 can use data from the ELDs 22 to enforce a speed threshold (e.g., a maximum permissible driving speed). If the speed is exceeded by a particular driver 12, the sound emitter 62 and/or status indicator 60 could be used to notify the driver 12 that they need to slow down.

The fleet managers 14 may use ELD data to enforce different maximum speeds based on different driving conditions. In one example, the ELD 22 receives windshield wiper operation information over the information bus 42, and if the information indicates windshield wipers are activated for more than a predefined time period (e.g., 30 seconds), the ELD 22 infers that the driver 12 is not just cleaning their windshield, but rather that the wipers are being operated because it is raining. The ELD 22 could then lower it speed threshold (e.g., maximum permitted speed), based on prior input of the fleet manager 14, because adverse weather conditions are more hazardous than standard driving conditions. A windshield wiper being “activated” could include the windshield wiper being continuously operated or turned on for intermittent, non-continuous operation.

In one example, fleet managers 14 can collect engine hours of use data to be used in connection with service, warranty, resale, or rental of the vehicle 20.

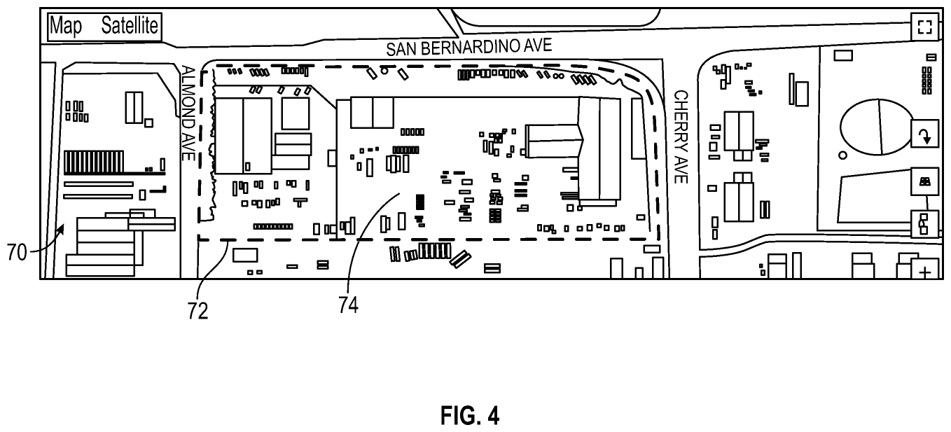

FIG. 4 illustrates a map 70 that depicts a territorial boundary 72, which may also be referred to as a “geo-fence,” that surrounds a geographic area 74 associated with a location (e.g., a location for loading and/or unloading cargo such as a loading bay). In one example, the map is presented to a driver 12 or fleet manager 14 through a client program (e.g., a web browser or a dedicated application), and the driver 12 or fleet manager 14 defines the territorial boundary 72 by interacting with the client program (e.g., by drawing the boundary on the map). The territorial boundary 72 could be drawn as a polygon, for example, in which case the geographic coordinates of the territorial boundary 72 could correspond to vertices of the polygon.

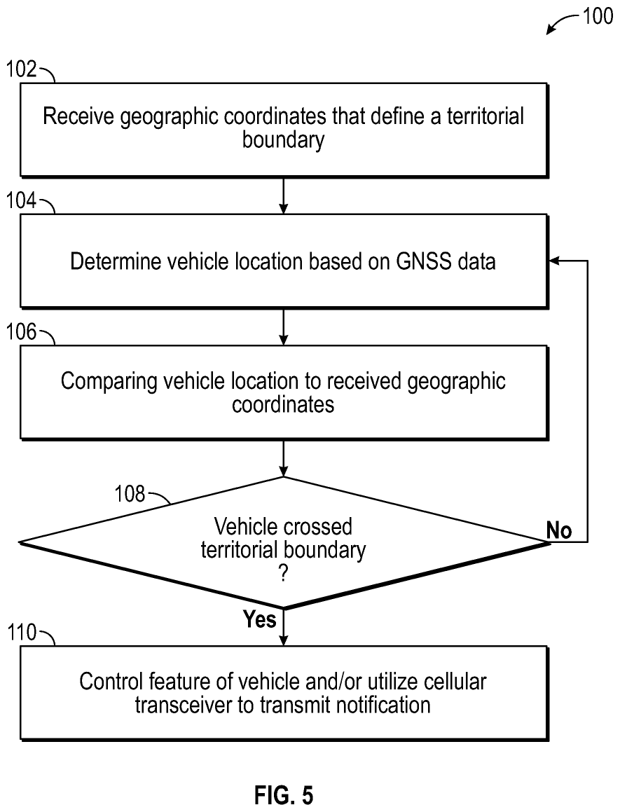

FIG. 5 is a flowchart that illustrates an example method 100 for the electronic logging system 10 that uses the territorial boundary 72. The method 100 may be performed by the ELD 22, for example. The processor 44 of ELD 22 receives geographic coordinates of the territorial boundary 72 (step 102). The geographic coordinates could be received from a fleet manager 14 using the cellular transceiver 52 or could be received from the mobile device 24 of the driver 12 using the Bluetooth transceiver 58 or USB port 56, for example. The processor 44 utilizes the GNSS receiver 48 to determine a current location of the vehicle 20 (step 104), and compares the current vehicle location to the geographic coordinates of the territorial boundary 72 (step 106).

The processor 44 determines whether the vehicle 20 has crossed the territorial boundary 72 (step 108), which would correspond to the vehicle 20 entering or exiting the geographic area 74. If the vehicle 20 has not crossed the territorial boundary 72 (a “no” to step 108), the ELD 22 repeats steps 104-108. If the vehicle 20 has crossed the territorial boundary 72 (a “yes” to step 108), the ELD 22 controls a feature of the vehicle 20 and/or utilizes the cellular transceiver 52 to transmit a notification (step 110).

By offloading the determination of whether the ELD 22 has crossed the territorial boundary from the server 16 to the ELDs 22, resources of the server 16 can be conserved, and cellular data usage can be reduced.

In one example, controlling the feature of the vehicle 20 could be a security feature. For example, if a driver 12 indicates that they are entering a rest period, the driver 12 or fleet manager 14 may set a territorial boundary 72 that if crossed would indicate that the vehicle 20 has been stolen and is being driven away. Controlling a feature of the vehicle 20 in step 110 in this context could include the ELD 22 limiting an ability of the vehicle 20 to be driven, such as by preventing a subsequent starting of the engine of the vehicle 20, turning off the engine of the vehicle 20, and/or restricting an ability of a fuel pump of the vehicle 20 to deliver fuel to the engine. In this example, the territorial boundary 72 would likely correspond to one vehicle 20, or a small number of vehicles 20 congregating together.

In one example, the territorial boundary 72 surrounds and corresponds to geographic area of a loading and/or unloading zone for loading and/or unloading cargo from the vehicle 20, and controlling the feature of the vehicle 20 in step 110 includes changing a state of a lock of a trailer of the vehicle 20 from a first state to a second state. This may include, for example, locking the trailer if the vehicle 20 is exiting a loading zone and/or unlocking the trailer of the vehicle 20 if the vehicle 20 is entering a loading zone.

In one example, step 108 includes determining that the vehicle 20 is approaching the location and is within a predefined distance of the location, and step 110 includes changing a state of the lock from a locked state to an unlocked state based on the determination that the vehicle is approaching the location and is within a predefined distance of the location.

In one example, step 108 includes determining that the vehicle is increasing its distance from the location and is more than a predefined distance away from the location, and step 110 includes changing the lock from an unlocked state to a locked state based on the determination that the vehicle is increasing its distance from the location and is more than a predefined distance away from the location.

In addition or as an alternative to controlling a feature of the vehicle 20, step 110 can include the ELD 22 utilizing its cellular transceiver 52 to transmit a notification to a remote device. In one example, the vehicle 20 transmits a notification to the location (e.g., a loading bay) and/or an individual associated with the location (e.g., a loading bay worker or manager) that the vehicle 20 has crossed the territorial boundary, is approaching the location, and is within a predefined distance of the location.

In one example, the vehicle 20 is a rental vehicle and the geographic area 74 surrounded by the territorial boundary 72 corresponds to a vehicle rental area, such as a parking lot or parking structure where rental vehicles are stored. Upon determining that the vehicle 20 has crossed the territorial boundary 72, the ELD 22 transmits a notification to a remote device, such as the server 16, which then initiates or terminates a vehicle rental period for the vehicle 20 based on the received message. This could include the server 16 invoking an API of a car rental company, for example.

If the vehicle 20 is entering the vehicle rental area, the notification could be used to terminate a rental period for the vehicle. If the vehicle 20 is exiting the vehicle rental area, the notification could be used to initiate a rental period for the vehicle. Such features could considerably expedite the process for obtaining and returning rental vehicles. In the rental vehicle example, the same geographic area 74 is more likely to be shared by a larger number of vehicles (e.g., an entire fleet), because the territorial boundary 72 of the vehicle rental area is relevant to a larger number of vehicles.

In one example, the notification is used to notify a worker at a loading and/or unloading location that the vehicle 20 is approaching and will needed to be loaded and/or unloaded soon.

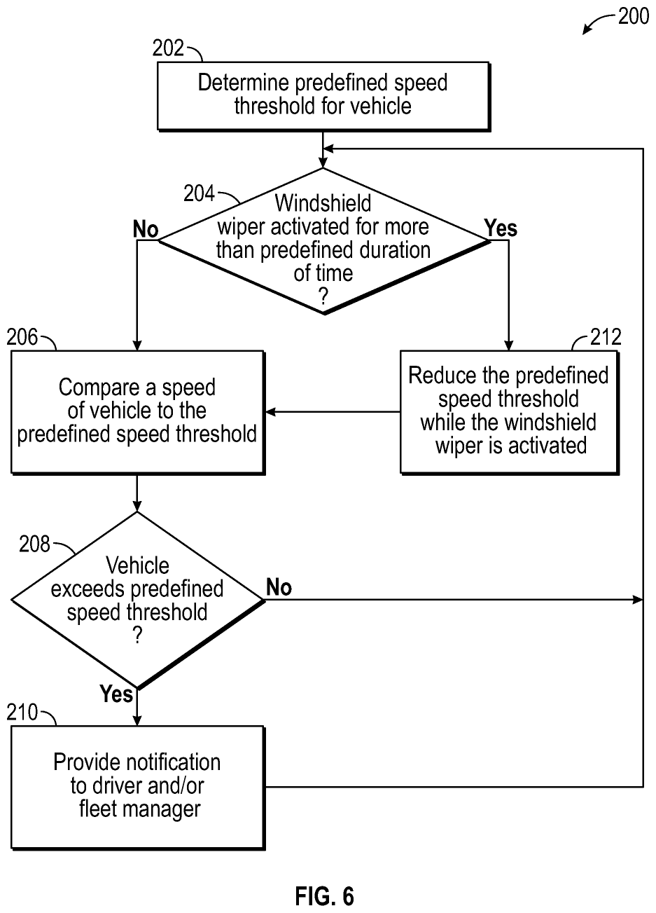

FIG. 6 is a flowchart 200 of an example method that relates to the windshield wiper example discussed above. A determination is made of a predefined speed threshold (e.g., a maximum permissible speed) for the vehicle 20 (step 202). The speed threshold may be assigned by a fleet manager, for example. A determination is made of whether a windshield of the wiper is activated for more than a predefined duration of time (step 204). In one example, the predefined duration of time corresponds to a time period during which the windshield wiper is automatically activated when windshield washer fluid is dispensed by the vehicle 20.

If the windshield wiper is not activated for more than a predefined duration of time (a “no” to step 204), the method proceeds to comparing a speed of the vehicle 20 to the predefined speed threshold (step 206), and determining whether the vehicle 20 exceeds the predefined speed threshold (step 208). The vehicle speed may be determined based on data from GNSS receiver 48 and/or from a vehicle speedometer (e.g., over information bus 42).

If the vehicle exceeds the predefined speed threshold (a “yes” to step 208), then a notification is provided to the driver of the vehicle 20 and/or a fleet manager for the vehicle 20 (step 210). The notification may be an alarm, for example, and may include a visual notification (e.g., on a vehicle electronic display), an audible notification, or both. In one particular example, the notification is provided to a driver of the vehicle through the status indicator 60 and/or sound emitter of FIG. 3.

If step 204 indicates that the windshield wiper is activated for more than the predefined duration of time, then the predefined speed threshold is reduced at least while the windshield wiper remains activated (step 212) and/or optionally for a longer duration of time. Operation of the windshield wipers for the predefined duration of time (e.g., 15 second or more), is a likely indicator that it is raining, and operation of the windshield wipers can be used as a inference that the vehicle is driving in the rain, and should lower its speed for safety. Because roads may be wet even after it stops raining and/or after windshield wipers stop operating, the speed threshold reduction of 212 may be continued for a predefined time period after the windshield wiper ceases to be activated (e.g., 5 minutes, 10 minutes, or some other duration of time).

The steps depicted in the flowchart 200 may be performed by the ELD 22, for example.

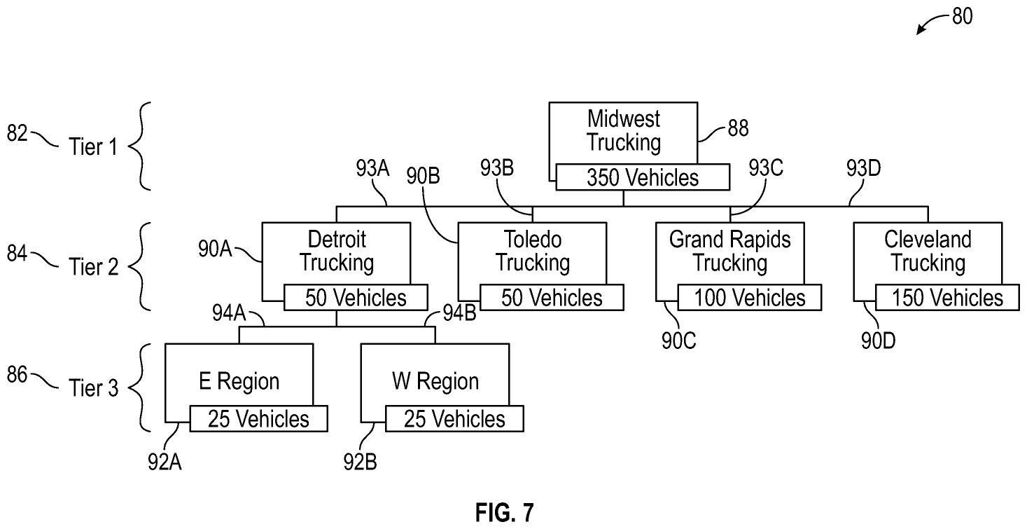

FIG. 7 schematically illustrates a multi-level permission hierarchy 80 for providing fleet managers 14 with hierarchical access to vehicle operation data. The hierarchy 80 includes a first tier 82, a second tier 84, and a third tier 86. Branches 93A-D connect vehicle sub-fleets 80A-D of the second tier 84 to vehicle fleet 88 in the first tier 82. Branches 94A-B connect vehicle sub-fleets 92A-B in the third tier 86 to sub-fleet 90A in the second tier 84.

Within the hierarchy 80, each fleet manager 80 at a given level can only view vehicle usage information for their one or more branches and any sub-branches of the hierarchy, but cannot view vehicle usage information from other branches of the hierarchy. Thus, a tier 1 user could view vehicle operation information for all tiers, a tier 2 user could vehicle usage information for their tier 2 fleet(s) and any sub-fleets, and a tier 3 user could only view tier 3 information for their own fleet(s).

Assume, for example, that fleet manager 14 is only associated with sub-fleet 90A (“Rex Trucking”) in the second tier 84, but no other first or second tier fleets. In that example, the fleet manager 14 could view vehicle usage information for branch 93A (corresponding to sub-fleet 90A) and sub branches 94A-B, (corresponding to sub-fleets 92A-B), but could not view vehicle usage information for branches 93B-D (corresponding to sub-fleets 90B-D). The fleet manager 14 having permission to view vehicle usage information for fleet 88 could view vehicle usage information for all sub-fleets shown in FIG. 6, because they are all connected through sub-branches 90A-D, 94A-B to the fleet 88.

The hierarchy 80 is highly adjustable, and an administrator could adjust the hierarchy 80 as needed, such as if some vehicles are temporarily associated with a given sub-fleet (e.g., rented/leased due to seasonal demand) The ability to reallocate such vehicles may alleviate the burden of temporarily outfitting those vehicles with ELDs 22, because the ELDs 22 could be already be installed prior to the temporary reallocation.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method comprising:
utilizing a global navigation satellite system (GNSS) receiver to determine a location of a vehicle;
determining, based on the location of the vehicle, whether the vehicle has crossed a territorial boundary associated with a location for loading or unloading cargo from a trailer of the vehicle; and
based on the vehicle having crossed the territorial boundary, changing a state of a lock of the trailer from a first state to a second state.

2. The method of claim 1, wherein:
said determining includes determining that the vehicle is approaching the location and is within a predefined distance of the location; and
said changing a state of the lock includes, based on the determination that the vehicle is approaching the location and is within a predefined distance of the location, changing the lock from the first state, which is a locked state, to the second state, which is an unlocked state.

3. The method of claim 2, wherein:
the location is a loading bay; and
the method includes transmitting a notification to the loading bay or an individual associated with the loading bay based on said determining that the vehicle is approaching the location and is within a predefined distance of the location.

4. The method of claim 1, wherein:
said determining includes determining that the vehicle is increasing its distance from the location and is more than a predefined distance away from the location; and
said changing a state of the lock includes, based on the determination that the vehicle is increasing its distance from the location and is more than a predefined distance away from the location, changing the lock from the first state, which is an unlocked state, to the second state, which is an locked state.

5. A device for a vehicle, comprising:
a global navigation satellite system (GNSS) receiver; and
a processor configured to:
utilize the GNSS receiver to determine a location of the vehicle;
determine, based on the location of the vehicle, whether the vehicle has crossed a territorial boundary associated with a location for loading or unloading cargo from a trailer of the vehicle; and
based on the vehicle having crossed the boundary, change a state of a lock of the trailer from a first state to a second state.

6. The device of claim 5, wherein:
the processor is configured to change the state of the lock from the first state, which is a locked state, to the second state, which is an unlocked state, based on the determination that the vehicle has crossed the territorial boundary and further based on a determination that the vehicle is approaching the location and is within a predefined distance of the location.

7. The device of claim 6, wherein:
the location is a loading bay; and
the processor is configured to transmit a notification to the loading bay or an individual associated with the loading bay based on the determinations that the vehicle has crossed the territorial boundary, is approaching the location, and is within a predefined distance of the location.

8. The device of claim 5, wherein:
the processor is configured to change the state of the lock from the first state, which is an unlocked state, to the second state, which is an locked state, based on the determination that the vehicle has crossed the territorial boundary and further based on a determination that the vehicle is increasing its distance from the location and is more than a predefined distance away from the location.

9. A method comprising:
comparing a speed of a vehicle to a predefined speed threshold;
providing a notification based on the speed of the vehicle exceeding the predefined speed threshold;
detecting that a windshield wiper of the vehicle is activated for more than a predefined duration of time; and
based on the detecting, reducing the predefined speed threshold.

10. The method of claim 9, wherein the predefined duration of time corresponds to a time period during which the windshield wiper is automatically activated based on windshield washer fluid being dispensed by the vehicle.

11. The method of claim 9, wherein said providing a notification includes:
providing a visual notification, an audible notification, or both, to a driver of the vehicle.

12. The method of claim 9, wherein said providing a notification includes:
transmitting a notification to a fleet manager of the vehicle.

13. The method of claim 9, wherein:
the method is performed by an electronic logging device of the vehicle, the electronic logging device connected to an information bus of the vehicle;
the electronic logging device performing said detecting based on information received over the information bus; and
the method includes recording, by the electronic logging device, data describing operation of the vehicle.

14. The method of claim 13, comprising:
determining the speed of the vehicle based on at least one of data from a global navigation satellite system (GNSS) receiver and data received over the information bus.

15. A device comprising:
memory; and
a processor operatively connected to the memory and configured to:
compare a speed of a vehicle to a predefined speed threshold;
provide a notification based on the speed of the vehicle exceeding the predefined speed threshold;
detect that a windshield wiper of the vehicle is activated for more than a predefined duration of time; and
based on the detection, reduce the predefined speed threshold.

16. The device of claim 15, wherein the predefined duration of time corresponds to a time period during which the windshield wiper is automatically activated based on windshield washer fluid being dispensed by the vehicle.

17. The device of claim 15, wherein to provide the notification, the processor is configured to:
provide a visual notification, an audible notification, or both, to a driver of the vehicle.

18. The device of claim 15, wherein to provide the notification, the processor is configured to:
transmit a notification to a fleet manager of the vehicle.

19. The device of claim 15, wherein:
the device is an electronic logging device of the vehicle, the electronic logging device connected to an information bus of the vehicle, configured to perform the detection based on information received over the information bus, and configured to record data describing operation of the vehicle.

20. The device of claim 19, wherein the processor is configured to:
determine the speed of the vehicle based on at least one of data from a global navigation satellite system (GNSS) receiver and data received over the information bus.
